(19) United States
(12) Patent Application Publication
(10) Pub. No.: US 2009/0127739 A1
(43) Pub. Date: May 21, 2009

(54) Two-stage method for producing belts

(76) Inventor: Hubert Göser, Dannenberg (DE)

Correspondence Address: WALTER OTTESEN, PO BOX 4026, GAITHERSBURG, MD, 20885-4026, US

(21) Appl. No.: 11/989,860

(22) PCT Filed: Jul. 22, 2006
(86) PCT No.: PCT/EP2006/007237

§ 371 Date: Feb. 1, 2008

(30) Foreign Application Priority Data
Sep. 21, 2005 (DE) 10 2005 044 988.3

(51) Int. Cl. B29D 29/00

(52) U.S. Cl. 264/257; 425/112

(57) ABSTRACT

In the two-step method according to the invention for producing belts from plasticatable material (5), a semi-finished product (2′) is produced in the first of the two steps and the finished belt is produced as an end product (2) from the semi-finished product (2′) in the second step by thermal shaping. To carry out the two-step method, two stations (6, 8) are provided. The first station (6) has a first rotatable mold wheel (14), a mold band (18), which is wrapped around a segment of the first mold wheel (14) with the aid of pressing and tension rollers (20, 22, 24) while keeping a hollow mold space (26) free, an extruder (10) and a filament feed (28). The second station (8) has a second mold wheel (16) and at least one pressing roller (34; 34a, 34b, . . . ). In particular for the production of belts for elevator/lifting technology (for example also for forklift trucks).

The invention relates to a two-step method for producing belts, in particular for the elevator technology/lifting technology (for example, also for fork lifts), and moreover to an apparatus for carrying out the method, according to the preambles of claims 1 and 9.

### PRIOR ART

DE 102 22 015 A1 discloses an apparatus which comprises two stations for producing belts in a two-step extrusion process (see FIG. 2 (Prior art) in addition to the brief description). The essential disadvantage is to be seen in the fact that first two part belts have to be produced and a separate extruder is required for each belt. This represents considerable expenditure on apparatuses. The two extruders also have to be synchronized exactly with one another. This requires high precision, otherwise a disproportionately high number of rejects would have to be expected.

A single-step method for producing belts from plasticatable material is also already known.

The disadvantage of this production method consists of the fact that a complex post-treatment of the belt blanks becomes necessary. For example, longitudinal ribs have to be machined out by milling and/or grinding. This results in high material losses since the material, which is machined off, can no longer be used. The production speed is limited because melting of the material has to be avoided during machining.

### OBJECT OF THE INVENTION

The object of the present invention comprises providing a simple extrusion process for producing belts (bands) in which the above-mentioned disadvantages are avoided. (In the following text, the terms “belt” and “band” are used next to one another in an equivalent manner.)

### SOLUTION AND ADVANTAGES

According to claim 1, the solution of this object comprises a two-step method: in a first method step, a semifinished product is produced which only has to be thermally formed in the second step to form the final product. A second extruder, as required in other two-step methods, can be omitted in the second step. The complete construction of the semifinished product takes place in a single method step by simultaneous feeding in tension elements and belt body material.

In addition, there is the possibility of feeding in a woven fabric material or a foil during the first method step in order to form the later belt back. Here, the woven fabric layer also serves to give the reinforcement elements a certain spacing from the belt back.

However, the woven fabric layer on the belt back does not only serve for the improved positioning of the reinforcement elements within the belt but also, as a belt covering, for influencing the coefficient of friction. For example, the coefficient of friction at the belt back can be set to be very low by PA woven fabrics, which has a positive effect on abrasion and noise development.

In addition, the woven fabric can also have an antistatic finish, in order to prevent any electrical charges which might build up.

The belt body material which emerges from the extruder in a plasticized state is cooled slightly on the peripheral surface of a first mold wheel. As a result, the semifinished product can be removed in a dimensionally stable manner.

A further advantage over the known single-step method consists in the fact that only so much plasticatable (preferably PU) material is used for the production of the semifinished product that no additional material has to be fed in or excess material removed for the subsequent forming process.

For the subsequent forming process in the second method step, the periphery of a second mold wheel for the polyurethane, which is preferably to be used, is heated to between 160° C. to 180° C.

The forming preferably takes place by more than one pressing roller. The semifinished product is pressed from the belt back into the profiled and heated mold wheel circumferential surface by the plurality of pressing rollers. Here, the future belt back assumes the circumferential surface structure of the second mold wheel.

The belt surface can be provided with any desired longitudinal and/or transverse profiles with the aid of a corresponding circumferential profiling of the second mold wheel.

### DRAWINGS

In the following text, the apparatus according to the invention will be described in greater detail using a comparison with the applicable prior art. In the drawings:

FIG. 1 shows a schematic view of the apparatus according to the invention for producing belts;

FIG. 2 shows a schematic view of an apparatus for producing belts according to the prior art.

### DESCRIPTION

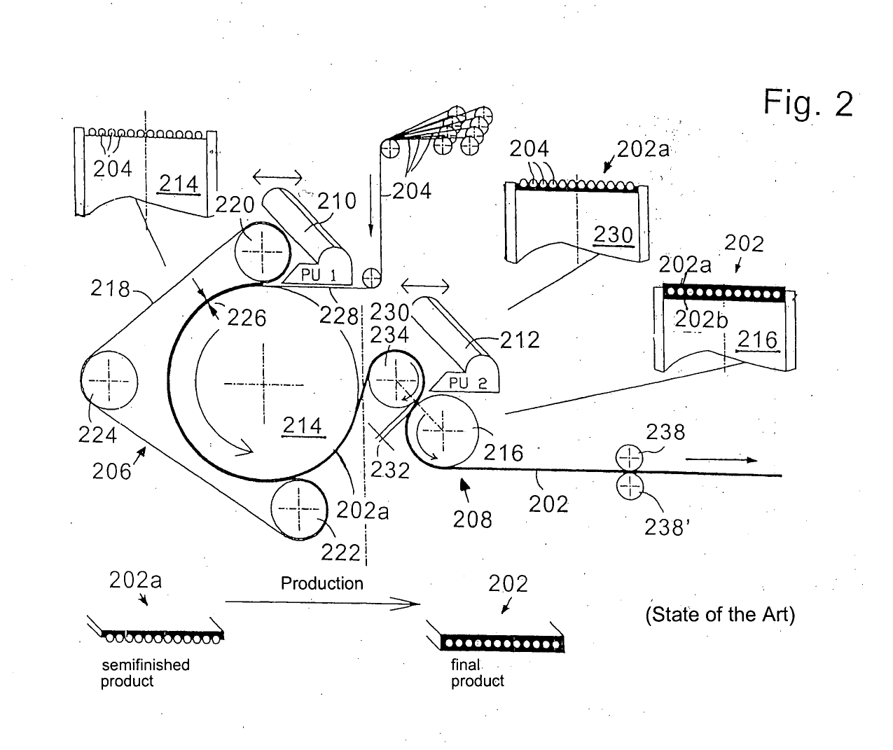

The conventional apparatus (shown in FIG. 2) for producing a belt 202 from plasticatable plastic material comprises two parts, namely a first station (“station 1”) 206 for producing a first part belt 202a which is provided with reinforcements 204 and a second station (“station 2”) 208 for producing a second part belt 202b and for joining the second part belt 202b to the first part belt 202a. The first station 206 as well as the second station 208 have respective extruders (210, 212) and respective mold wheels (214, 216). Moreover, the first station 206 has a continuous mold band 218. The mold band 218 forms a mold space 226 along a part circumference of the mold wheel 214 with the aid of an upper pressure roller 220, a lower pressure roller 222 and a tension roller 224. Moreover, there is a filament feed 228. In addition, the second station 208 has a second roller which is a pressing roller 234 and/or tension roller 230.

The spacing 232 between the second roller 230 or 234 and the (second) mold wheel 216 can be adjusted. This spacing corresponds to the thickness of the belt 202 to be produced. The belt 202 which leaves the second mold wheel 216 is loaded with a predefined tensile force and is guided over two

rollers (238, 238′).

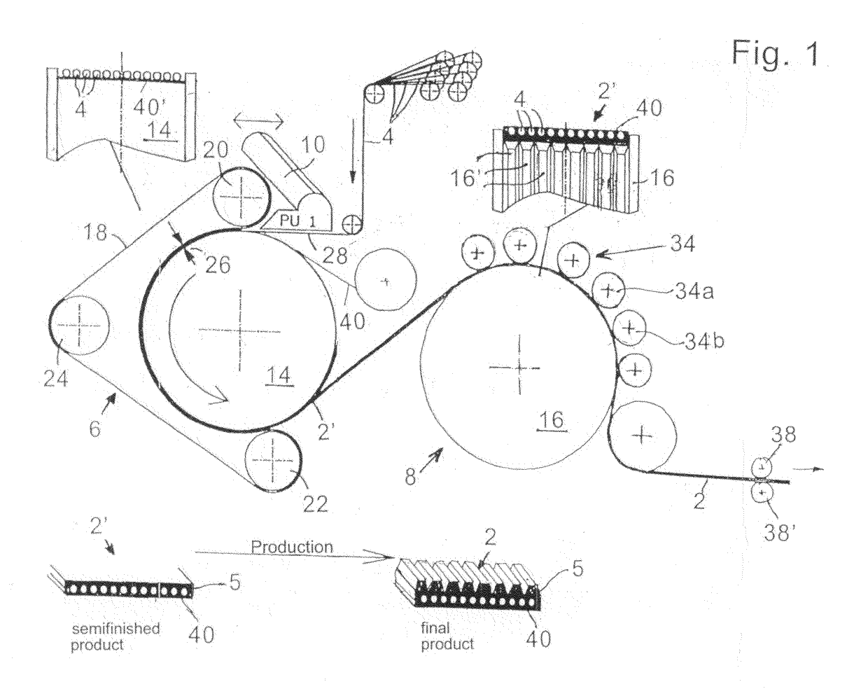

The apparatus according to the invention which is shown in FIG. 1 likewise has two stations (6, 8), but there is only a single extruder 10. While the first station 6 (for carrying out the first method step) has substantial common features with the conventional apparatus, the second station 8 (for carrying out the second method step) differs in principle from the previously known construction.

### In Detail

The first station 6 likewise comprises a mold wheel 14 which can rotate in the counterclockwise direction and an endless mold band 18 which wraps around a part section of the mold wheel 14. The ends of the part section are likewise defined by an “upper” pressure roller 20 and a “lower” pressure roller 22 in conjunction with a tension roller 24. A mold space 26 is likewise formed between the part section of the mold band 18 and the circumference of the mold wheel 14 which lies below it. The pressure of the mold band 18 on the mold wheel 14 can also be set with the aid of a tension roller 24. Moreover, the “station 1” 6 has an extruder 10 and a filament feed 28 as known.

The first method step is carried out with the aid of this first station 6. Here, according to the invention, a semifinished product 2′ is produced which is only thermally shaped in the second method step with the aid of the second station to form the final product (finished band, belt) 2.

The semifinished product 2′, which is to be produced in the first station 6, comprises reinforcement elements 4, belt body material (preferably polyurethane, PU) 5 and optionally a woven fabric cover 40 on the later belt back. In order to produce the semifinished product 2′, the PU 5 is plasticized in the extruder 10 and fed to the mold wheel 14. At the same time, the reinforcement elements 4 are fed to the mold wheel 14 tangentially below the PU melt 5. Optionally, a further elastomer or woven fabric layer 40′ can be fed in below the pull plane. This layer 40′ then serves to give the reinforcement elements 4 an additional spacing from the belt back. The peripheral surface of the mold wheel 14 is temperature controlled (cooled) in such a way that the semifinished product 2′ can be removed from the first station 6 in a form stable manner. Here, so much PU 5 is used for producing the semifinished product 2′ that no additional material 5 has to be fed in or excess material 5 removed for the forming process to produce the final product (finished band, belt) 2.

The second station 8 likewise has a mold wheel 16, the circumferential surface of which, as required, has a profile 16′. Moreover, there are at least one pressing

roller (34; 34a, 34b, . . . ) and two guide rollers (38, 38′). A (second) extruder is not needed in this second station 8.

For the production of the final product 2, only a shaping of the semifinished product 2′ takes place in the second stage 8. For this purpose, the temperature of the circumferential surface of the second mold wheel 16 is controlled in such a way that one-sided thermal shaping of the semifinished product 2′ is possible. The temperature should preferably lie between 160° C. and 180° C. for polyurethane 5.

The semifinished product 2′ is fed to the temperature controlled mold wheel 16 of the second station 8 in such a way that the side, which is to be shaped, faces the profiled and heated mold wheel peripheral surface 16′. The semifinished product 2′ is then pressed more and more at the back of the belt into the profiled peripheral surface 16′ of the mold wheel 16 by a plurality of pressing rollers (34a, 34b, . . . ). The belt then assumes the circumferential surface structure 16′ of the mold wheel 16. After the shaping process has ended, the belt is pulled off from the mold wheel 16 of the second station 8 as a shaped final product 2. For improved demolding of the final product 2, the circumferential surface 16′ of the second mold wheel 16 is provided with a nonstick coating.

### LIST OF DESIGNATIONS

### FIG. 2 (Prior Art)

202 Belt
202a First part belt
202b Second part belt
204 Reinforcement
206 “Station 1” (part of the apparatus)
208 “Station 2” (part of the apparatus)
210, 212 Extruder
214, 216 Mold wheel
218 Mold band
220 “Upper” pressure roller
222 “Lower” pressure roller
224 Tension roller
226 Hollow mold space
228 Filament feed
230 Direction-changing roller
232 Spacing between the roller 230 or 234 and the (second) mold wheel 216
234 Pressing roller
238, 238′ Guide roller/rollers

### FIG. 1

2 Final product, (finished) belt, band
2′ Semifinished product
4 Reinforcement element(s)
5 Belt body material, material, for example polyurethane (PU)
6 “Station 1”, first station
8 “Station 2”, second station
10 Extruder
14 Mold wheel of the first station
16 Mold wheel of the second station
16′ Profile of the second mold wheel 16, profiled circumferential surface of the mold wheel
18 Endless mold band
20 “Upper” pressure roller
22 “Lower” pressure roller
24 Tension roller
26 Mold space
28 Filament feed
34; 34a, 34b, . . . . Pressing roller/rollers
38, 38′ Guide roller/rollers
40 Woven fabric cover, woven fabric layer, foil
40′ (Additional) layer, elastomer or woven fabric layer

1-14. (canceled)

15. An apparatus for making a belt made of plasticatable material, the apparatus comprising:
a first station for making a semifinished product;
said first station including:
a first rotatable mold wheel;
a mold belt assembly including a mold belt wrapped around a portion of said first mold wheel so as to conjointly define a mold space therewith; and, a plurality of pressure and tension rollers acting on said mold belt to hold said mold belt in contact with said portion of said first mold wheel while maintaining said mold space;
a filament feed for feeding filaments into said mold space; and,
an extruder for outputting said plasticatable material onto said first mold wheel thereby permitting said semifinished product to be formed with said filaments in said mold space as said mold wheel rotates;
a second station for receiving said semifinished product to produce said belt therefrom;
said second station including a second mold wheel for receiving and thermally shaping said semifinished product to form said belt as an end product; and,
at least one pressing roller for applying pressure to said semifinished product on said second mold wheel.

16. The apparatus of claim 15, wherein said first station further includes a feed for feeding a woven fabric layer into said mold space.

17. The apparatus of claim 15, wherein the temperature of the circumferential surface of said first mold wheel is set in such a way that said semifinished product can be removed from said first station in a dimensionally stable manner.

18. The apparatus of claim 15, wherein the temperature of the periphery of said second mold wheel is set between 160° C. and 180° C. when polyurethane is used as said plasticatable material.

19. The apparatus of claim 17, wherein said circumferential surface of said second mold wheel has a longitudinal and/or transverse and/or diagonal profile.

20. The apparatus of claim 17, wherein the circumferential surface of said second mold wheel is provided with a non-adhering coating.

21. A two-step method for making a belt from plasticatable material, the method comprising the steps of:
making a semifinished product in a first step; and,
in a second step, thermally shaping said semifinished product to produce said belt as a finished product.

22. The two-step method of claim 21, wherein, in said first step, said semifinished product is built up from reinforcement elements and said plasticatable material.

23. The two-step method of claim 22, wherein an extruder is provided for plasticating said material and a feed is provided for supplying said reinforcement elements; and, said first method step includes feeding the plasticated material to a mold wheel while simultaneously supplying said reinforcement elements to said mold wheel tangentially below said plasticated material to form said semifinished product.

24. The two-step method of claim 23, wherein a fabric layer or foil is supplied simultaneously with the plasticated material for forming the later back of said belt.

25. The two-step method of claim 24, wherein the temperature of the peripheral surface of said mold wheel is so adjusted that said semifinished product is dimensionally stable when taken off said mold wheel.

26. The two-step method of claim 25, wherein, in said second step, said belt is produced as said finished product from said semifinished product by shaping said semifinished product.

27. The two-step method of claim 26, wherein said semifinished product is shaped with a one-sided thermal shaping with the aid of a second mold wheel which is profiled on the periphery thereof and is heatable.

28. The two-step method of claim 27, wherein said semifinished product is pressed more and more by a plurality of pressing rollers into the profiled peripheral surface of said second mold wheel at the back of said semifinished product whereby said belt assumes the surface structure of said second mold wheel.
